(19) United States
(12) Patent Application Publication
(10) Pub. No.: US 2024/0173757 A1
(43) Pub. Date: May 30, 2024

(54) APPARATUS AND METHOD FOR WASHING AND DECONTAMINATING SOIL

(71) Applicant: YUH SHAN ENVIRONMENTAL ENGINEERING CO., LTD., Kaohsiung City (TW)

(72) Inventors: Huang-Long LIN, Kaohsiung City (TW); Li-Peng CHANG, Kaohsiung City (TW); Chien-Chang HUANG, Kaohsiung City (TW)

(21) Appl. No.: 18/352,259

(22) Filed: Jul. 14, 2023

(30) Foreign Application Priority Data
Nov. 29, 2022 (TW) 111145546

(51) Int. Cl. B09C 1/02; B01D 11/02

(52) U.S. Cl. CPC B09C 1/02; B01D 11/0261

(57) ABSTRACT

An apparatus for washing and decontaminating soils includes a high-pressure microbubble generation module, a coarse grain heterogeneous separation module, an ultrasonic shock module, and a fine grain heterogeneous separation module. The high-pressure microbubble generation module generates first microbubbles, and uses a first shock energy generated when the first microbubbles burst to remove an oil contaminant on coarse grain soils. The coarse grain heterogeneous separation module uses the difference in density to separate the oil contaminant and the coarse grain soils from a soil and water mixture. The ultrasonic shock module generates second microbubbles and performs an ultrasonic shock operation to increase a second shock energy generated when the second microbubbles burst to remove another oil contaminant on fine grain soils. The fine grain heterogeneous separation module uses the difference in density to separate the another oil contaminant and the fine grain soils from the soil and water mixture.

### RELATED APPLICATIONS

This application claims priority to Taiwan Application Serial Number 111145546, filed Nov. 29, 2022, which is herein incorporated by reference.

### BACKGROUND

### Field of Invention

The present disclosure relates to a soil decontamination technology, and more particularly, to an apparatus and a method for washing and decontaminating soils.

### Description of Related Art

The soil washing and decontaminating technology is a common remediation technology for polluted soils. In the operation of the soil washing and decontaminating apparatus, the polluted soils are usually put into a drum sand washing machine, and the polluted soils are washed by the drum sand washing machine after injecting water into the polluted soils. By rolling, the total petroleum hydrocarbons adhering to surfaces of the soils are separated and desorbed from the surfaces of the soils, so as to achieve the washing and cleaning treatment of the soils.

Such a soil washing apparatus cleans the soils mainly by using the energy generated when the soils are stirred and collided during the rolling process, such that the cleaning ability is limited by the stirring energy. In addition, the soil washing apparatus cannot evenly stir the soils, such that the effect of cleaning polluted soils is limited. Furthermore, the polluted soil washing apparatus is mainly for cleaning the coarse grain soils and cannot deal with the contaminants on the fine grain soil sands, such that the washing process of the polluted soils is not comprehensive, and the complete soil washing and cleaning effect cannot be achieved.

### SUMMARY

Therefore, one objective of the disclosure is to provide an apparatus and a method for washing and decontaminating soils, in which a high-pressure microbubble generation module is used to generate microbubbles, and then a shock energy generated when the microbubbles burst is used to remove contaminants on surfaces of coarse grain soils in the soils. After the coarse grain soils are separated, an ultrasonic shock module is used to generate ultrasonic waves and microbubbles, so as to simultaneously use an energy of ultrasonic waves and a shock energy of the microbubbles to effectively remove contaminants on surfaces of fine grain soils. Therefore, the present disclosure can use various energies to carry out a comprehensive decontamination treatment on the polluted soils, thereby greatly enhancing a washing and decontaminating effect of the soils.

Another objective of the present disclosure is to provide an apparatus and a method for washing and decontaminating soils, in which when heterogeneous separation modules are used to separate coarse grain soils and fine grain soils, oil contaminants separated from the soils can be floated and scraped off, such that it can prevent the oil contaminants from reintegrating and causing pollution, thereby effectively removing the oil contaminants on the soils.

According to the aforementioned objectives, the present disclosure provides an apparatus for washing and decontaminating soils, which includes a high-pressure microbubble generation module, a coarse grain heterogeneous separation module, an ultrasonic shock module, and a fine grain heterogeneous separation module. The high-pressure microbubble generation module is configured to push a soil and water mixture in a feeding pipeline and generate plural first microbubbles in the soil and water mixture, so as to use a first shock energy generated when the first microbubbles burst to at least remove an oil contaminant adhering to plural coarse grain soils in the soil and water mixture. The soil and water mixture includes the coarse grain soils and plural fine grain soils. The coarse grain heterogeneous separation module is disposed next the high-pressure microbubble generation module, and is configured to receive the soil and water mixture and use differences among a density of the coarse grain soils, a density of the oil contaminant, and a density of the fine grain soils to respectively separate the oil contaminant and the coarse grain soils from the soil and water mixture. The ultrasonic shock module is disposed next the coarse grain heterogeneous separation module, and is configured to receive the soil and water mixture from the coarse grain heterogeneous separation module, generate plural second microbubbles in the soil and water mixture, and perform an ultrasonic shock operation on the soil and water mixture to increase a second shock energy generated when the second microbubbles burst to remove another oil contaminant adhering to the fine grain soils. The fine grain heterogeneous separation module is disposed next the ultrasonic shock module, and is configured to receive the soil and water mixture and use a difference between the density of the fine grain soils and a density of the another oil contaminant to respectively separate the another oil contaminant and the fine grain soils from the soil and water mixture.

According to one embodiment of the present disclosure, the high-pressure microbubble generation module includes a feeding pump and a high-pressure microbubble generator. The feeding pump is connected to the feeding pipeline, and is configured to pressurize and push the soil and water mixture in the feeding pipeline. The high-pressure microbubble generator is connected to the feeding pipeline and is configured to generate the first microbubbles.

According to one embodiment of the present disclosure, the high-pressure microbubble generator includes a necking section and a gas introduction tube. The gas introduction tube is disposed on the necking section and is connected to the necking section, and the first microbubbles are generated in the necking section.

According to one embodiment of the present disclosure, each of the coarse grain heterogeneous separation module and the fine grain heterogeneous separation module includes a rectification precipitator.

According to one embodiment of the present disclosure, the ultrasonic shock module includes a high-pressure microbubble generator and an ultrasonic vibrator. The high-pressure microbubble generator is connected to the feeding pipeline and is configured to generate the second microbubbles. The ultrasonic vibrator is located next the high-pressure microbubble generator and disposed on the feeding pipeline. The ultrasonic vibrator is configured to generate ultrasonic waves to perform the ultrasonic shock operation on the soil and water mixture.

According to the aforementioned objectives, the present disclosure further provides a method for washing and decontaminating soils. In this method, plural first microbubbles are generated in a soil and water mixture. A first shock energy generated when the first microbubbles burst in the soil and water mixture is used to at least remove an oil contaminant adhering to plural coarse grain soils in the soil and water mixture. The soil and water mixture includes the coarse grain soils and plural fine grain soils. The oil contaminant and the coarse grain soils are respectively separated from the soil and water mixture by using differences among a density of the coarse grain soils, a density of the oil contaminant, and a density of the fine grain soils. Plural second microbubbles are generated in the soil and water mixture after the coarse grain soils are separated. An ultrasonic shock operation is performed on the soil and water mixture to increase a second shock energy generated when the second microbubbles burst to remove another oil contaminant adhering to the fine grain soils. The another oil contaminant and the fine grain soils are respectively separated from the soil and water mixture by using a difference between the density of the fine grain soils and a density of the another oil contaminant.

According to one embodiment of the present disclosure, each of the generating of the first microbubbles and the generating of the second microbubbles includes using a high-pressure microbubble generator.

According to one embodiment of the present disclosure, the high-pressure microbubble generator includes a necking section and a gas introduction tube, the gas introduction tube is disposed on the necking section and connected to the necking section, and the first microbubbles and the second microbubbles are formed in the necking sections.

According to one embodiment of the present disclosure, performing the ultrasonic shock operation further includes making the fine grain soils rub against each other.

According to one embodiment of the present disclosure, respectively separating the oil contaminant and the coarse grain soils from the soil and water mixture includes using a coarse grain heterogeneous separation module, respectively separating the another oil contaminant and the fine grain soils from the soil and water mixture includes using a fine grain heterogeneous separation module, and each of the coarse grain heterogeneous separation module and the fine grain heterogeneous separation module includes a rectification precipitator.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a schematic diagram of an apparatus for washing and decontaminating soils in accordance with one embodiment of the present disclosure.

FIG. 2 is a schematic diagram of a high-pressure microbubble generation module of an apparatus for washing and decontaminating soils in accordance with one embodiment of the present disclosure.

FIG. 3 is a schematic diagram of a coarse grain heterogeneous separation module of an apparatus for washing and decontaminating soils in accordance with one embodiment of the present disclosure.

FIG. 4 is a schematic diagram of an ultrasonic shock module of an apparatus for washing and decontaminating soils in accordance with one embodiment of the present disclosure.

FIG. 5 is a schematic diagram of a fine grain heterogeneous separation module of an apparatus for washing and decontaminating soils in accordance with one embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms. Furthermore, the spatial relationship between two elements described in the present disclosure applies not only to the orientation depicted in the drawings, but also to the orientations not represented by the drawings, such as the orientation of the inversion.

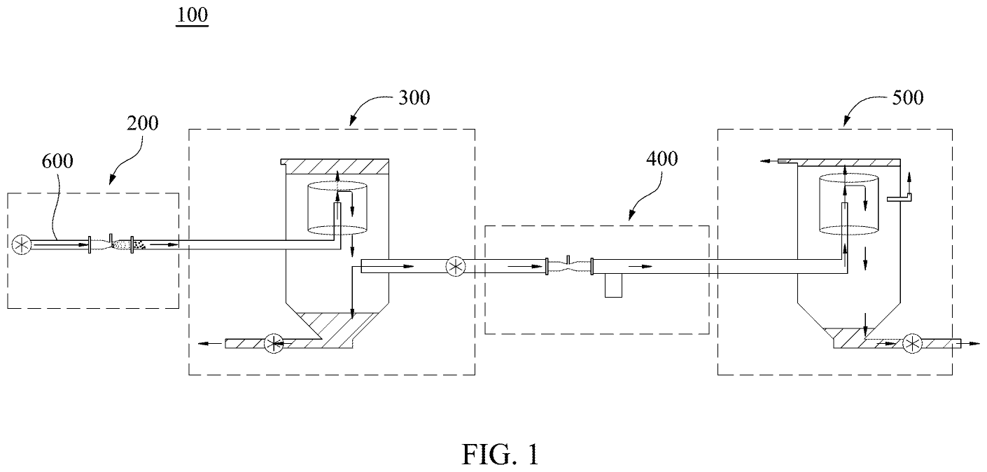

Referring to FIG. 1, FIG. 1 is a schematic diagram of an apparatus for washing and decontaminating soils in accordance with one embodiment of the present disclosure. An apparatus 100 for washing and decontaminating soils can perform a water washing and decontaminating treatment on soils, such as an oil contaminant removal treatment. The apparatus 100 for washing and decontaminating the soils may mainly include a high-pressure microbubble generation module 200, a coarse grain heterogeneous separation module 300, an ultrasonic shock module 400, and a fine grain heterogeneous separation module 500. The transportation of a soil and water mixture 700 between the high-pressure microbubble generation module 200, the coarse grain heterogeneous separation module 300, the ultrasonic shock module 400, and the fine grain heterogeneous separation module 500 is mainly through a feeding pipeline 600.

As shown in FIG. 1, the high-pressure microbubble generation module 200, the coarse grain heterogeneous separation module 300, the ultrasonic shock module 400, and the fine grain heterogeneous separation module 500 are arranged sequentially from upstream to downstream. The soil and water mixture 700 includes coarse grain soils 710 (referring to FIG. 3), fine grain soils 730 (referring to FIG. 5), and water, in which oil contaminants adhere to surfaces of the coarse grain soils 710 and surfaces of the fine grain soils 730. The coarse grain soils 710 may be sands, while the fine grain soils 730 may be mud with a particle size smaller than sand.

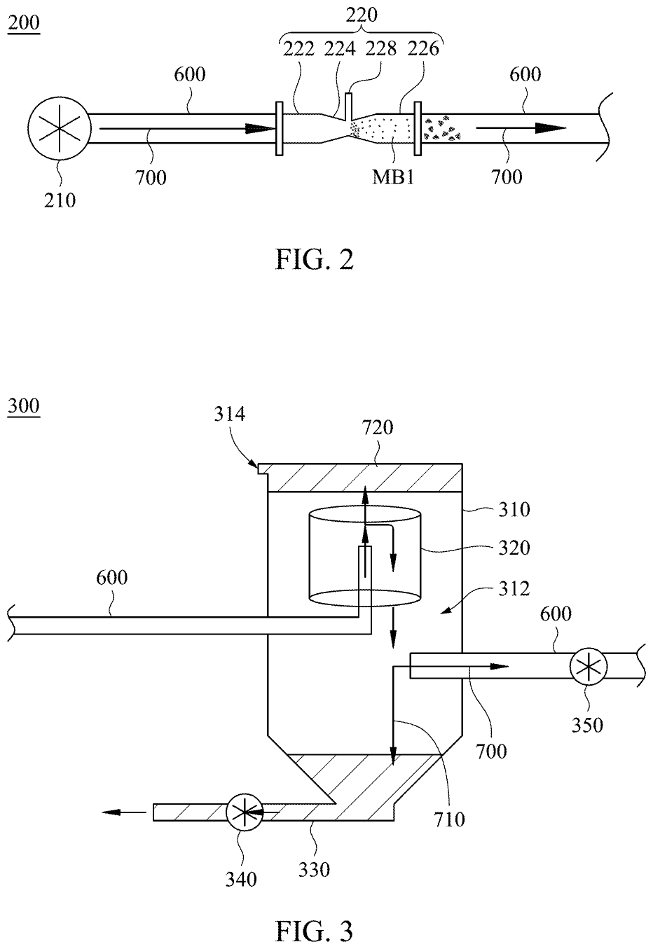

Referring to FIG. 2, FIG. 2 is a schematic diagram of a high-pressure microbubble generation module of an apparatus for washing and decontaminating soils in accordance with one embodiment of the present disclosure. The high-pressure microbubble generation module 200 can push the soil and water mixture 700 in the feeding pipeline 600, and generate many first microbubbles MB1 in the soil and water mixture 700. The adhesion between the coarse grain soils 710 and the oil contaminant is smaller than that between the fine grain soils 730 and the oil contaminant, so the high-pressure microbubble generation module 200 is used to remove the oil contaminants on the surfaces of the coarse grain soils 710 at this stage of the washing and decontaminating treatment. Specifically, the high-pressure microbubble generation module 200 generates the first microbubble MB1, and utilizes a first shock energy generated when the first microbubble MB1 burst to at least remove the oil contaminant adhering to the coarse grain soils 710 in the soil and water mixture 700.

In some examples, the high-pressure microbubble generation module 200 includes a feeding pump 210 and a high-pressure microbubble generator 220. The feeding pump 210 is connected to the feeding pipeline 600, and can pressurize and push the soil and water mixture 700 in the feeding pipeline 600 to transport the soil and water mixture 700 downstream. The feeding pump 210 may be, for example, a motor pump. The high-pressure microbubble generator 220 is connected to the feeding pipeline 600 and is located next the feeding pump 210. The high-pressure microbubble generator 220 can generate the first microbubbles MB1. In some examples, the high-pressure microbubble generator 220 includes an inlet section 222, a necking section 224, an outlet section 226, and a gas introduction tube 228. The inlet section 222, the necking section 224, and the outlet section 226 are sequentially connected to each other along an advancing direction of the material. The gas introduction tube 228 is disposed on the necking section 224 and is connected to the necking section 224. A radial dimension of the necking section 224 gradually shrinks from the inlet section 222, and then gradually increases to the outlet section 226, such that the combination of the inlet section 222, the necking section 224, and the outlet section 226 forms a funnel-like structure.

When the soil and water mixture 700 enters the high-pressure microbubble generator 220 through the feeding pipeline 600, the soil and water mixture 700 first enters the inlet section 222, and then enters the necking section 224. The necking section 224 tapers from the junction with the inlet section 222, such that the velocity of the soil and water mixture 700 in the necking section 224 increases and the pressure decreases, which is the Venturi effect. The pressure change in the necking section 224 drives the external air to enter the necking section 224 from the gas introduction tube 228, and the air entering the necking section 224 enters the water of the soil and water mixture 700 under the high pressure to form the first microbubbles MB1. After the first microbubbles MB1 gradually move away from the necking section 224 and enter the outlet section 226, the first microbubbles MB1 expand and burst due to the widening of the pipeline. A first shock energy generated when the first microbubbles MB1 burst can be transmitted to the polluted soils in the water, so as to at least shatter the oil contaminant on the surfaces of the coarse grain soils 710 and to separate the oil contaminants from the coarse grain soils 710, thereby achieving an effect of high energy decontamination. The first shock energy generated when the first microbubbles MB1 burst may also impact the oil contaminant on the surfaces of the fine grain soils 730, such that it may remove a portion of the oil contaminant on the surfaces of the fine grain soils 730.

Also referring to FIG. 3, FIG. 3 is a schematic diagram of a coarse grain heterogeneous separation module of an apparatus for washing and decontaminating soils in accordance with one embodiment of the present disclosure. The coarse grain heterogeneous separation module 300 is disposed next the high-pressure microbubble generation module 200, and is fluidly connected to the high-pressure microbubble generation module 200 through the feeding pipeline 600. The coarse grain heterogeneous separation module 300 receives the soil and water mixture 700 that has passed through the high-pressure microbubble generation module 200. In some examples, the coarse grain heterogeneous separation module 300 separates an oil contaminant 720 and the coarse grain soils 710 from the soil and water mixture 700 respectively by using differences among a density of the coarse grain soils 710, a density of the oil contaminant 720, and a density of the fine grain soils 730. In such examples, the coarse grain heterogeneous separation module 300 may include a housing 310, a rectification precipitator 320, and a discharge pipeline 330. The coarse grain heterogeneous separation module 300 may further optionally include a discharge pushing pump 340 and a feeding pump 350.

The housing 310 has an accommodating space 312. The rectification precipitator 320 is located in the accommodating space 312 of the housing 310. The feeding pipeline 600 penetrates into the housing 310, and then penetrates into the rectification precipitator 320 from a bottom of the rectification precipitator 320 to carry the soil and water mixture 700 into the rectification precipitator 320. The discharge pipeline 330 is located on a bottom of the housing 310 and is fluidly connected to the housing 310. The discharge pushing pump 340 is located on the discharge pipeline 330. The other side of the housing 310 is provided with the feeding pipeline 600, and a level of the feeding pipeline 600 on this side is lower than a level of the feeding pipeline 600 that carries the soil and water mixture 700 into the housing 310. The feeding pump 350 is disposed in the feeding pipeline 600 on this side. One side of a top of the housing 310 is provided with an oil discharge port 314.

The soil and water mixture 700 is conveyed into the rectification precipitator 320 through the feeding pipeline 600, such that the soil and water mixture 700 can be separated in a steady state by the differences in density between the coarse grain soils 710, the oil contaminant 720, and the fine grain soils 730. The density of the oil contaminant 720 is smaller than that of water, such that the oil contaminant 720 can float. Then, the oil contaminant 720 may be scraped off by using a scraper, and discharged through the oil discharge port 314 on the top of the housing 310. Thus, it can prevent the oil contaminant 720 from reintegrating into the soil and water mixture 700 to cause pollution. On the other hand, the coarse grain soils 710 in which the oil contaminant 720 has been removed from its surface rapidly precipitate on the bottom of the rectification precipitator 320 because their density is greater than that of water. Subsequently, the coarse grain soils 710 on the bottom of the rectification precipitator 320 are guided to the bottom of the housing 310. Then, the coarse grain soils 710 are discharged from the housing 310 through the discharge pipeline 330 by using the discharge pushing pump 340. The fine grained soils 730 containing the oil contaminant have a slower sedimentation rate because their density is slightly greater than that of water. During sedimentation, the fine grain soils 730 and water are pumped into the feeding pipeline 600 and further pumped to the ultrasonic shock module 400 through the feeding pump 350 to continue the next stage of soil cleaning.

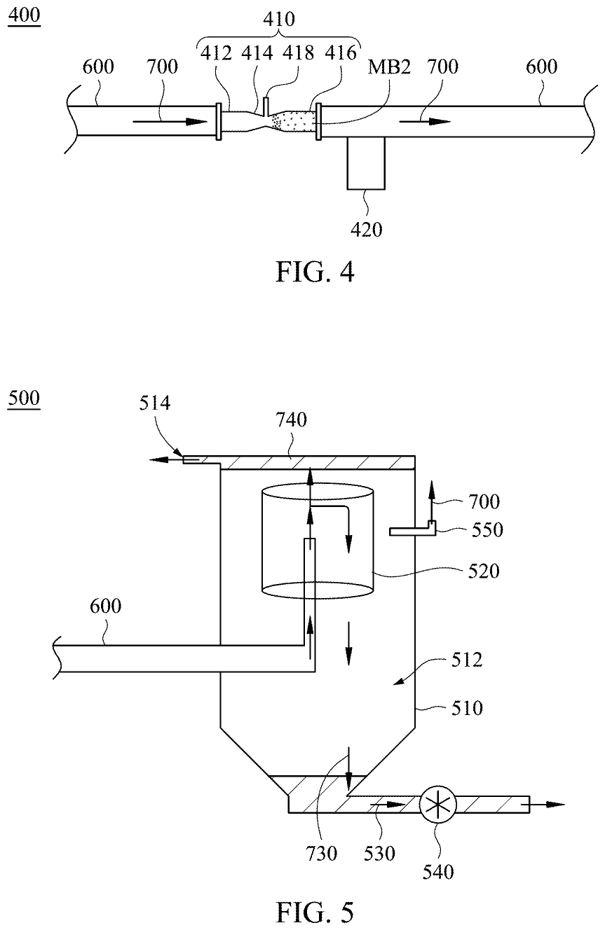

Referring to FIG. 4, FIG. 4 is a schematic diagram of an ultrasonic shock module of an apparatus for washing and decontaminating soils in accordance with one embodiment of the present disclosure. The ultrasonic shock module 400 is disposed next the coarse grain heterogeneous separation module 300, and is fluidly connected to the coarse grain heterogeneous separation module 300 through the feeding pipeline 600. The ultrasonic shock module 400 receives the soil and water mixture 700 from the coarse grain heterogeneous separation module 300, and the coarse grain soils 710 have been separated from the soil and water mixture 700. The ultrasonic shock module 400 can generate many second microbubbles MB2 in the soil and water mixture 700, and can perform an ultrasonic shock operation on the soil and water mixture 700. The adhesion between fine grain soils and the oil contaminant is greater than that between the coarse grain soils and the oil contaminant, so the ultrasonic shock module 400 with a greater decontamination ability is used to remove the oil contaminant on the surfaces of the fine grain soils at this stage.

In some examples, the ultrasonic shock module 400 includes a high-pressure microbubble generator 410 and an ultrasonic vibrator 420. The high-pressure microbubble generator 410 is connected to the feeding pipeline 600, and can generate the second microbubbles MB2. In some examples, the high-pressure microbubble generator 410 includes an inlet section 412, a necking section 414, an outlet section 416, and a gas introduction tube 418. The high-pressure microbubble generator 410 is substantially a funnel structure. Specifically, the inlet section 412, the necking section 414, and the outlet section 416 are sequentially connected to each other along the advancing direction of the material, and a radial dimension of the necking section 414 gradually shrinks from the inlet section 412, and then gradually increases to the outlet section 416. The gas introduction tube 418 is disposed on the necking section 414 and is fluidly connected to the necking section 414. The ultrasonic vibrator 420 is located next the high-pressure microbubble generator 410 and disposed on the feeding pipeline 600. The ultrasonic vibrator 420 can generate ultrasonic waves through vibration, such that the ultrasonic shock operation can be performed on the soil and water mixture 700.

Similar to the high-pressure microbubble generator 220, the high-pressure microbubble generator 410 also utilizes the Venturi effect to drive the external air into the necking section 414 through the gas introduction tube 418, and further into the water of the soil and water mixture 700 to form the second microbubbles MB2. The ultrasonic vibrator 420 next the high-pressure microbubble generator 410 then performs the ultrasonic shock operation on the soil and water mixture 700, so as to use the ultrasonic waves to vibrate and impact the second microbubbles MB2 in the soil and water mixture 700. Such ultrasonic vibration impact can increase a second shock energy generated when the second microbubbles MB2 burst, such that another oil contaminant adhering to the fine grain soils 730 is shattered and separated from the fine grain soils 730, thereby achieving a higher energy decontamination effect. In addition, the ultrasonic vibration impact can evenly burst the second microbubble MB2, and can also vibrate the fine grain soils 730 to make them rub against each other, which can greatly enhance the cleaning effect of the soils.

Referring to FIG. 5, FIG. 5 is a schematic diagram of a fine grain heterogeneous separation module of an apparatus for washing and decontaminating soils in accordance with one embodiment of the present disclosure. The fine grain heterogeneous separation module 500 is disposed next the ultrasonic shock module 400, and is fluidly connected to the ultrasonic shock module 400 through the feeding pipeline 600. After the soil and water mixture 700 is further cleaned by the ultrasonic shock module 400, the soil and water mixture 700 is conveyed to the fine grain heterogeneous separation module 500 through the feeding pipeline 600. In some examples, after receiving the soil and water mixture 700, the fine grain heterogeneous separation module 500 separates an oil contaminant 740, which is released from the fine grain soils 730, and the fine grain soils 730 from the soil and water mixture 700 respectively by using a difference between the density of the fine grain soils 730 and a density of the oil contaminant 740. In such examples, the fine grain heterogeneous separation module 500 may include a housing 510, a rectification precipitator 520, a discharge pipeline 530, and a drain pipeline 550. The fine grain heterogeneous separation module 500 may further optionally include a discharge pushing pump 540.

The housing 510 has an accommodating space 512. The rectification precipitator 520 is located in the accommodating space 512 of the housing 510. The feeding pipeline 600 penetrates into the housing 510, and then penetrates into the rectification precipitator 520 from a bottom of the rectification precipitator 520 to carry the soil and water mixture 700 into the rectification precipitator 520. The discharge pipeline 530 is located on a bottom of the housing 510 and communicates with the housing 510. The discharge pushing pump 540 is located on the discharge pipeline 530. The drain pipeline 550 penetrates into the other side of the housing 510. A level of the drain pipeline 550 is higher than a level of the feeding pipeline 600, but lower than a level of a top of the rectification precipitator 520. One side of a top of the housing 510 is provided with an oil discharge port 514.

The soil and water mixture 700 is conveyed into the rectification precipitator 520 through the feeding pipeline 600, such that the soil and water mixture 700 can be separated in a steady state by the difference in density between the fine grain soils 730 and the oil contaminant 740. The density of the oil contaminant 740 is smaller than that of water, such that the oil contaminant 740 can float. The oil contaminant 740 may be scraped off by using a scraper, and discharged through the oil discharge port 514 on the top of the housing 510 to prevent the oil contaminant 740 from reintegrating into the soil and water mixture 700 to cause pollution. On the other hand, the fine grain soils 730 in which the oil contaminant 740 has been removed from their surface precipitate on the bottom of the rectification precipitator 520 because their density is greater than that of water. Next, the fine grain soils 730 on the bottom of the rectification precipitator 520 are guided to the bottom of the housing 510. Then, the fine grain soils 730 are discharged from the housing 510 through the discharge pipeline 530 by using the discharge pushing pump 540. After separation, most of the remaining soil and water mixture 700 is water, and can be discharged from the housing 510 through the drain pipeline 550.

In the water washing and decontaminating treatment of soils, the feeding pump 210 of the high-pressure microbubble generation module 200 may be used to push the soil and water mixture 700 in the feeding pipeline 600, and the high-pressure microbubble generator 220 may be used to generate many first microbubbles MB1 in the soil and water mixture 700. The first shock energy generated when these first microbubbles MB1 burst in the soil and water mixture 700 is used to at least shatter the oil contaminant 720 adhering to the coarse grain soils 710 in the soil and water mixture 700 to separate the oil contaminant 720 from the coarse grain soils 710.

Next, the coarse grain heterogeneous separation module 300 may be used to respectively separate the oil contaminant 720 and the coarse grain soils 710 from the soil and water mixture 700 according to the differences among the density of the coarse grain soils 710, the density of the oil contaminant 720, and the density of the fine grain soils 730. In the separation operation, the soil and water mixture 700 may be conveyed to the rectification precipitator 320 to make the soil and water mixture 700 be in a stable state, and then the coarse grain soils 710 precipitating on the bottom of the rectification precipitator 320 are exported. Meanwhile, the floating oil contaminant 720 can be scraped off.

Then, the high-pressure microbubble generator 410 of the ultrasonic shock module 400 is used to generate many second microbubbles MB2 in the soil and water mixture 700 after heterogeneous separation. Next, the ultrasonic vibrator 420 is used to perform the ultrasonic shock operation on the soil and water mixture 700 to generate ultrasonic waves to vibrate and impact the second microbubble MB2 in the soil and water mixture 700. The ultrasonic vibration impact can increase the second shock energy, and shatter and remove the oil contaminant 740 on the fine grain soils 730. The ultrasonic vibration impact can evenly burst the second microbubble MB2, and can also vibrate the fine grain soils 730 to make them rub against each other, thereby further enhancing the cleaning effect of the soils.

Subsequently, the fine grain heterogeneous separation module 500 may be used to respectively separate the oil contaminant 740 and the fine grain soils 730 from the soil and water mixture 700 according to the difference between the density of the fine grain soils 730 and the density of the oil contaminant 740. In the separation operation, the soil and water mixture 700 may be conveyed to the rectification precipitator 520 to make the soil and water mixture 700 be in a stable state, and then the fine grain soils 730 precipitating on the bottom of the rectification precipitator 520 are exported. Meanwhile, the floating oil contaminant 740 can be scraped off. The water washing and decontaminating process of the soils has been substantially completed.

According to the aforementioned embodiments, one advantage of the present disclosure is that the present disclosure uses a high-pressure microbubble generation module to generate microbubbles, and then uses a shock energy generated when the microbubbles burst to remove contaminants on surfaces of coarse grain soils in the soils. After the coarse grain soil is separated, an ultrasonic shock module is used to generate ultrasonic waves and microbubbles, so as to simultaneously use an energy of ultrasonic waves and a shock energy of the microbubbles to effectively remove contaminants on surfaces of fine grain soils. Therefore, the present disclosure can use various energies to carry out a comprehensive decontamination treatment on the polluted soils, thereby greatly enhancing a washing and decontaminating effect of the soils.

Another advantage of the present disclosure is that when the present disclosure uses heterogeneous separation modules to separate coarse grain soils and fine grain soils, oil contaminants separated from the soils can be floated and scraped off, such that it can prevent the oil contaminants from reintegrating and causing pollution, thereby effectively removing the oil contaminants on the soils.

The features of several embodiments are outlined above, so those skilled in the art can understand the aspects of the present disclosure. Those skilled in the art will appreciate that the present disclosure can be readily utilized as a basis for designing or modifying other processes and structures, thereby achieving the same objectives and/or achieving the same advantages as the embodiments described herein. Those skilled in the art should also understand that these equivalent constructions do not depart from the spirit and scope of the present disclosure, and they can make various changes, substitutions, and alteration without departing from the spirit and scope of the present disclosure.

What is claimed is:

1. An apparatus for washing and decontaminating soils, comprising:
a high-pressure microbubble generation module configured to push a soil and water mixture in a feeding pipeline and generate a plurality of first microbubbles in the soil and water mixture, so as to use a first shock energy generated when the first microbubbles burst to at least remove an oil contaminant adhering to a plurality of coarse grain soils in the soil and water mixture, wherein the soil and water mixture comprises the coarse grain soils and a plurality of fine grain soils;
a coarse grain heterogeneous separation module disposed next the high-pressure microbubble generation module, and configured to receive the soil and water mixture and use differences among a density of the coarse grain soils, a density of the oil contaminant, and a density of the fine grain soils to respectively separate the oil contaminant and the coarse grain soils from the soil and water mixture;
an ultrasonic shock module disposed next the coarse grain heterogeneous separation module, and configured to receive the soil and water mixture from the coarse grain heterogeneous separation module, generate a plurality of second microbubbles in the soil and water mixture, and perform an ultrasonic shock operation on the soil and water mixture to increase a second shock energy generated when the second microbubbles burst to remove another oil contaminant adhering to the fine grain soils; and
a fine grain heterogeneous separation module disposed next the ultrasonic shock module, and configured to receive the soil and water mixture and use a difference between the density of the fine grain soils and a density of the another oil contaminant to respectively separate the another oil contaminant and the fine grain soils from the soil and water mixture.

2. The apparatus for washing and decontaminating the soils of claim 1, wherein the high-pressure microbubble generation module comprises:
a feeding pump connected to the feeding pipeline and configured to pressurize and push the soil and water mixture in the feeding pipeline; and
a high-pressure microbubble generator connected to the feeding pipeline and configured to generate the first microbubbles.

3. The apparatus for washing and decontaminating the soils of claim 2, wherein the high-pressure microbubble generator comprises a necking section and a gas introduction tube, the gas introduction tube is disposed on the necking section and connected to the necking section, and the first microbubbles are generated in the necking section.

4. The apparatus for washing and decontaminating the soils of claim 1, wherein the coarse grain heterogeneous separation module comprises a rectification precipitator.

5. The apparatus for washing and decontaminating the soils of claim 1, wherein the fine grain heterogeneous separation module comprises a rectification precipitator.

6. The apparatus for washing and decontaminating the soils of claim 1, wherein the ultrasonic shock module comprises:
a high-pressure microbubble generator connected to the feeding pipeline and configured to generate the second microbubbles; and
an ultrasonic vibrator located next the high-pressure microbubble generator and disposed on the feeding pipeline, wherein the ultrasonic vibrator is configured to generate ultrasonic waves to perform the ultrasonic shock operation on the soil and water mixture.

7. A method for washing and decontaminating soils, comprising:
generating a plurality of first microbubbles in a soil and water mixture;
using a first shock energy generated when the first microbubbles burst in the soil and water mixture to at least remove an oil contaminant adhering to a plurality of coarse grain soils in the soil and water mixture, wherein the soil and water mixture comprises the coarse grain soils and a plurality of fine grain soils;
using differences among a density of the coarse grain soils, a density of the oil contaminant, and a density of the fine grain soils to respectively separate the oil contaminant and the coarse grain soils from the soil and water mixture;
generating a plurality of second microbubbles in the soil and water mixture after the coarse grain soils are separated;
performing an ultrasonic shock operation on the soil and water mixture to increase a second shock energy generated when the second microbubbles burst to remove another oil contaminant adhering to the fine grain soils; and
using a difference between the density of the fine grain soils and a density of the another oil contaminant to respectively separate the another oil contaminant and the fine grain soils from the soil and water mixture.

8. The method for washing and decontaminating the soils of claim 7, wherein generating the first microbubbles comprises using a high-pressure microbubble generator.

9. The method for washing and decontaminating the soils of claim 8, wherein the high-pressure microbubble generator comprises a necking section and a gas introduction tube, the gas introduction tube is disposed on the necking section and connected to the necking section, and the first microbubbles are formed in the necking section.

10. The method for washing and decontaminating the soils of claim 7, wherein generating the second microbubbles comprises using a high-pressure microbubble generator.

11. The method for washing and decontaminating the soils of claim 10, wherein the high-pressure microbubble generator comprises a necking section and a gas introduction tube, the gas introduction tube is disposed on the necking section and connected to the necking section, and the second microbubbles are formed in the necking section.

12. The method for washing and decontaminating the soils of claim 7, wherein performing the ultrasonic shock operation further comprises making the fine grain soils rub against each other.

13. The method for washing and decontaminating the soils of claim 7, wherein respectively separating the oil contaminant and the coarse grain soils from the soil and water mixture comprises using a coarse grain heterogeneous separation module.

14. The method for washing and decontaminating the soils of claim 13, wherein the coarse grain heterogeneous separation module comprises a rectification precipitator.

15. The method for washing and decontaminating the soils of claim 7, wherein respectively separating the another oil contaminant and the fine grain soils from the soil and water mixture comprises using a fine grain heterogeneous separation module.

16. The method for washing and decontaminating the soils of claim 15, wherein the fine grain heterogeneous separation module comprises a rectification precipitator.
